(19) United States
(12) Patent Application Publication
(10) Pub. No.: US 2007/0268295 A1
(43) Pub. Date: Nov. 22, 2007

(54) POSTURE ESTIMATION APPARATUS AND METHOD OF POSTURE ESTIMATION

(75) Inventor: Ryuzo OKADA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/749,443

(22) Filed: May 16, 2007

(30) Foreign Application Priority Data
May 19, 2006 (JP) 2006-140129

(51) Int. Cl. G06T 15/70

(52) U.S. Cl. 345/474

(57) ABSTRACT

An apparatus includes a posture dictionary configured to hold a tree structure of postures configured on the basis of image features with occlusion information and image features, an image capture unit, an image feature extracting unit, a posture prediction unit taking the occlusion information into consideration, and a tree structure posture estimation unit. The posture prediction unit performs prediction by setting a prediction range of dynamic models of portions where the occlusion occurs, larger than a prediction range of dynamic models of portions which are not occluded on the basis of the past posture estimation information and the occlusion information of the respective portions.

### CROSS-REFERENCE TO RELATED APPLICATIONS

This application is based upon and claims the benefit of priority from the prior Japanese Patent Application No. 2006-140129, filed on May 19, 2006; the entire contents of which are incorporated herein by reference.

### TECHNICAL FIELD

The present invention relates to a non-contact posture estimation apparatus for human bodies using images captured by a camera without using a marker or the like.

### BACKGROUND OF THE INVENTION

Japanese Application Kokai No. 2000-99741 (FIG. 2 in P.5) discloses a method of restoring a human posture from a three-dimensional position of feature points including a fingertip or a tiptoe using a plurality of camera images. This method requires a plurality of cameras for acquiring three-dimensional positions, and cannot be realized with a single camera. It is difficult to extract positions of the respective feature points for various postures stably from images because such feature points may occluded by the other parts of the human body (self-occlusion).

Japanese application Kokai No. 9-198504 discloses a method of searching an optimum posture using a genetic algorithm (GA) when estimating a posture through matching of silhouettes of a person which is obtained by a plurality of camera images and those of a virtual person in various postures obtained from virtual cameras arranged in the same layout as the plurality of cameras. The virtual person and the virtual cameras are realized in a computer. This apparatus also requires the plurality of cameras.

According to a method disclosed in “Filtering Using a Tree-Based Estimator”, B. Stenger, A. Thayananthan, P. H. S. Torr, and R. Cipolla, In Proc. 9^{th} IEEE International Conference on Computer Vision, Vol. II, pages 1063-1070, 2003, disclosed is a method of estimating a hand posture, which achieves posture estimation with a single camera. Human bodies and hands both have a joint structure, and hence a similar method can be applied to estimation of the human body. In this document, a tree structure which is prepared in advance is used for estimating the posture through the matching of image features (edges) acquired from images and those (outlines) obtained from a three-dimensional hand model in various postures. Each node of this tree structure consists of a set of postures whose difference in joint angle is small, and the difference becomes smaller as it goes to the lower levels. By performing the matching of the image features following this tree structure toward the lower level, the coarse-to-fine search of the posture is achieved, so that the posture search is efficiently performed. The results of recognition of the respective levels are expressed by a probability distribution which is calculated from temporal continuity of posture (dynamic model) and goodness of the matching of the image features, and efficient search is achieved by eliminating nodes which has lower probability when proceeding to the matching of the lower level. There may be a case in which there are a small number of cameras and hence the posture cannot be determined uniquely only from the image features. However, such ambiguity is solved by considering the temporal continuity of the posture.

However, even through the image features are almost the same, postures having significantly different joint angles belong to different nodes, and hence redundant search is performed. There are cases in which the postures are different by 180° with the same outline; for example in a case of the postures of a human body facing forward and facing backward, and a case in which arms hidden behind the torso assumes various postures (self-occlusion). Since the temporal continuity of the posture is employed, it is difficult to estimate postures of an occluded potion if its posture changes significantly during occlusion. For example, when the posture of the arm occluded by the torso assumes a completely different posture before and after occlusion, the posture of the arm is not continued before and after the occlusion, and hence accurate estimation is not achieved.

### BRIEF SUMMARY OF THE INVENTION

In order to solve the above-described problem, it is an object of the invention to provide a posture estimation apparatus and a method of posture estimation which enables efficient and stable estimation of human body postures taking occluded portion of the human body into consideration.

According to embodiments of the present invention, there is provided an apparatus for estimating current posture information of a human body from an image of the human body captured by one or more image capture devices. The apparatus comprises a posture dictionary, an image feature extracting unit, a past information storage unit, a posture predicting unit, a node predicting unit, a similarity calculating unit, a node probability calculating unit and a posture estimation unit. The posture dictionary stores tree structure data which includes a plurality of nodes. Each of the plurality of nodes includs (A) posture information on various postures of the human body obtained in advance, (B) image feature information on the respective postures and (C) representing posture information indicating representing posture of the various postures in the respective nodes. The image feature information includes (B-1) information on at least one of silhouettes, (B-2) outlines of the respective postures and (B-3) occlusion information on portions of the human body which are occluded by the human body itself. The nodes is arranged in such a manner that the nodes in the lower level includes postures having higher similarity than in the higher level. The image feature extracting unit extracts image feature information observed from the images obtained by the image capture device. The past information storage unit stores past posture estimation information of the human body. The posture predicting unit predicts a predicted posture based on the past posture estimation information and the occlusion information of the respective portions. The posture predicting unit sets a predicted range of a dynamic model for occluded portions larger than that for potions without occlusion. The node predicting unit calculates a prediction probability relating to whether a correct posture corresponding to the current posture is included in the respective nodes of the respective levels of the tree structure using the predicted range and the past posture estimation information. The similarity calculating unit calculates the similarity between the observed image feature information and the image feature information on the representing postures in the respective nodes stored in the posture dictionary. The node probability calculating unit calculates the probability that the correct posture is included in the respective nodes of the respective levels from the prediction probabilities and the similarity in the respective nodes. The posture estimation unit selects posture information which is closest to the predicted posture from the plurality of postures included in the node having the highest probability in the lowest level of the tree structure as the current posture estimation information.

According to the embodiments of the invention, the nodes of the tree structure consist of postures having small difference in image features, and the matching of the image features is performed using the tree structure, so that redundant matching for the postures whose image features are substantially the same is avoided, and hence efficient posture search is achieved.

Since the respective nodes of the tree structure in the embodiments of the invention each are configured with the postures whose image features are substantially the same, when the obtained image features are substantially the same even though the joint angle is different as described above, the current posture is determined from among these postures while taking the temporal continuity of the posture into consideration. The occlusion information on the respective portions are added to the respective postures used for matching, and the constraint of the temporal continuity of the postures is alleviated for the occluded portions. Accordingly, the non-continuity of the postures before and after the occlusion is allowed, so that the improvement of robustness for the posture estimation of the occluded portion is achieved. In this configuration, the non-contact posture estimation apparatus for human bodies using images without using a marker or the like in which both of efficiency and robustness are satisfied can be realized.

### BRIEF DESCRIPTION OF THE DRAWINGS

FIG. 1 is a block diagram showing a configuration of a posture estimation apparatus for a human body using images according to an embodiment of the invention;

FIG. 2 is a block diagram showing a configuration of a dictionary generating unit;

FIG. 3 is an explanatory drawing of a portion index projected image;

FIG. 4 is an explanatory drawing showing registered information of model silhouette into a posture dictionary A;

FIG. 5 is an explanatory drawing showing a model outline;

FIG. 6 is a flowchart showing contents of processing by a tree structure generating unit;

FIG. 7 is an explanatory drawing relating to a method of storing data to be registered into the posture dictionary A;

FIG. 8 is a block diagram showing a configuration of the image feature extracting unit 2; and

FIG. 9 is a block diagram showing a configuration of a tree structure posture estimation unit.

### DETAILED DESCRIPTION OF THE INVENTION

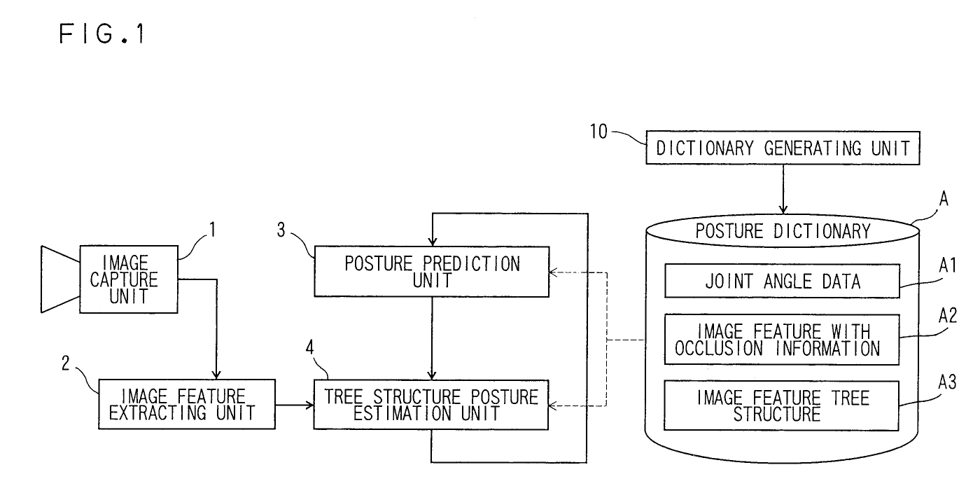

Referring now to FIG. 1 to FIG. 9, a posture estimation apparatus according to an embodiment of the invention will be described.

### (1) Configuration of Posture Estimation Apparatus

FIG. 1 is a block diagram showing a posture estimation apparatus for human bodies according to the embodiment of the invention.

The posture estimation apparatus includes a posture dictionary A that stores information on various postures, an image capture unit 1 that captures images, an image feature extracting unit 2 that extracts image features such as a silhouette or an edge from an image acquired by the image capture unit 1, a posture prediction unit 3 that predicts postures in a current frame using the result of estimation in the previous frame and information in the posture dictionary A, and a tree structure posture estimation unit 4 that estimates a current posture using the information of the predicted posture and the image features extracted by the image feature estimation unit 2 on the basis of the tree structure of the posture stored in the posture dictionary A.

The posture estimation apparatus is realized by, for example, using a general computer apparatus as a basic hardware. That is, the image feature extracting unit 2, the posture prediction unit 3, and the tree structure posture estimation unit 4 are realized by causing a processor mounted in the computer apparatus to execute a program. At this time, the posture estimation apparatus may be realized by installing the program into the computer apparatus in advance, or may be realized by installing the program in the computer apparatus as needed by storing the program in a storage medium such as a CD-ROM, or by distributing the program through a network. The posture dictionary A is realized by utilizing a memory provided externally or integrally with the computer apparatus, a hard disk, or storage media such as CD-R, CD-RW, DVD-RAM, DVD-R and so on as needed.

In this specification, the term “prediction” means to obtain information on the current posture only from information on the postures in the past. The term “estimation” means to obtain the information on the current posture from the information on the predicted current posture and an image of the current posture.

### (2) Posture Dictionary A

The posture dictionary A is prepared in advance before performing the posture estimation. The posture dictionary A stores a tree structure data including a plurality of nodes each including joint angle data A1 for various postures, an image feature with occluded information A2 obtained from the three-dimensional shape data of a body of a person whose posture is estimated relating to the respective postures, and representing posture information A3 indicating representing posture of the various postures in the respective nodes.

### (3) Dictionary Generating Unit 10

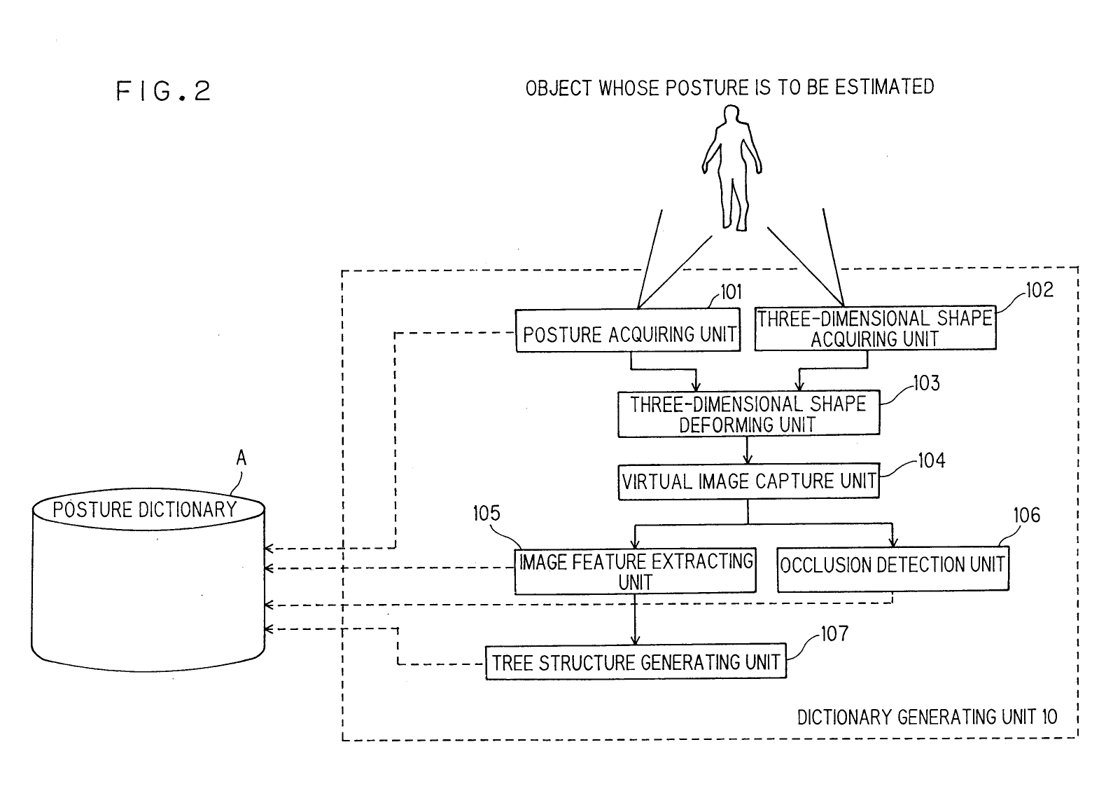

FIG. 2 is a block diagram showing a configuration of a dictionary generating unit 10 that generates the posture dictionary A.

A method of preparing the posture dictionary A by the dictionary generating unit 10 will be described.

### (3-1) Posture Acquiring Unit 101

A posture acquiring unit 101 collects the joint angle data A1 and includes a commercially available motion capture system using markers or sensors or the like.

Since redundant postures are included in the acquired postures, the similar postures are deleted as follows.

Each of the joint angle data A1 is a set of three rotational angles rx, ry, rz (Euler angles) about three-dimensional space axes of the respective joints. Assuming that human body has joints by the number Nb, posture data Xa of a posture “a” is expressed as: Xa={rx1, ry1, rz1, rx2, . . . , r (Nb) }. The difference between two posture data Xa and Xb is defined as a maximum absolute difference of the respective elements of the posture data, that is, as a maximum absolute difference of the respective rotational angles of the joint angles, and one of the postures is deleted when the difference of the postures is smaller than a certain value.

### (3-2) Three-Dimensional Shape Acquiring Unit 102

A three-dimensional shape acquiring unit 102 measures a person whose posture is to be estimated by a commercially available three-dimensional scanner or the like, and acquires vertex position data of polygons which approximates the shape of the surface of the human body.

When there are too many polygons, the number of vertexes is reduced, and a three-dimensional shape model of a human body is generated by setting positions of the joints (such as elbows, knees, shoulders) of the human body and portions (such as upper arms, head, chest) of the human body to which all the polygons belong.

Although such operation may be performed by any methods, in general, it is manually performed using commercially available software for computer graphics. Reduction of the vertexes may be achieved automatically by a method of thinning the vertexes at regular distances or by a method of thinning the vertexes more from a portion of the surface having a smaller curvature. It is also possible to prepare a plurality of three-dimensional shape models of standard body shapes instead of the person whose posture is actually estimated as described above, and select a three-dimensional shape model which is most similar to the body shape of the person to be estimated.

### (3-3) Three-Dimensional Shape Deforming Unit 103

A three-dimensional shape deforming unit 103 changes positions of vertexes of the polygons which constitute the three-dimensional model by setting the joint angles in the respective postures acquired by the posture acquiring unit 101 to the respective joints of the three-dimensional shape model of the human body generated by the three-dimensional shape acquiring unit 102, so that the three-dimensional shape model is deformed to the respective postures.

### (3-4) Virtual Image Capture Unit 104

A virtual image capture unit 104 generates the projected images of the three-dimensional shape model in the respective postures by projecting the polygons which constitute the three-dimensional shape models deformed into the respective postures by the three-dimensional shape deforming unit 103 onto an image plane with a virtual camera which is configured in a computer having the same camera parameters as the image capture unit 1 while taking the occlusion relations thereof into consideration.

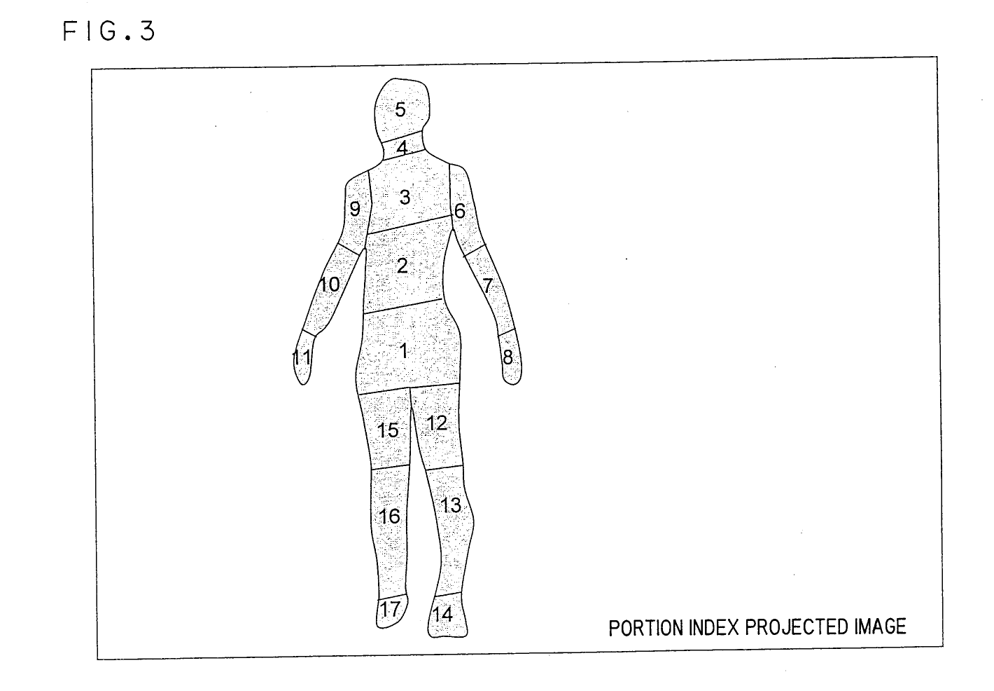

When projecting the polygons into the image, index numbers of portions of a human body is set to be values of pixels to which the polygons projected so that a projected image with portion indexes is generated as shown in FIG. 3.

### (3-5) Image Feature Extracting Unit 105

An image feature extracting unit 105 extracts a silhouette and an outline from the projected image with the portion indexes generated by the virtual image capture unit 104 as image features, and prepares a “model silhouette” and a “model outline”. These image features are stored in the posture dictionary A in coordination with the joint angle data of the posture.

### (3-5-1) Model Silhouette

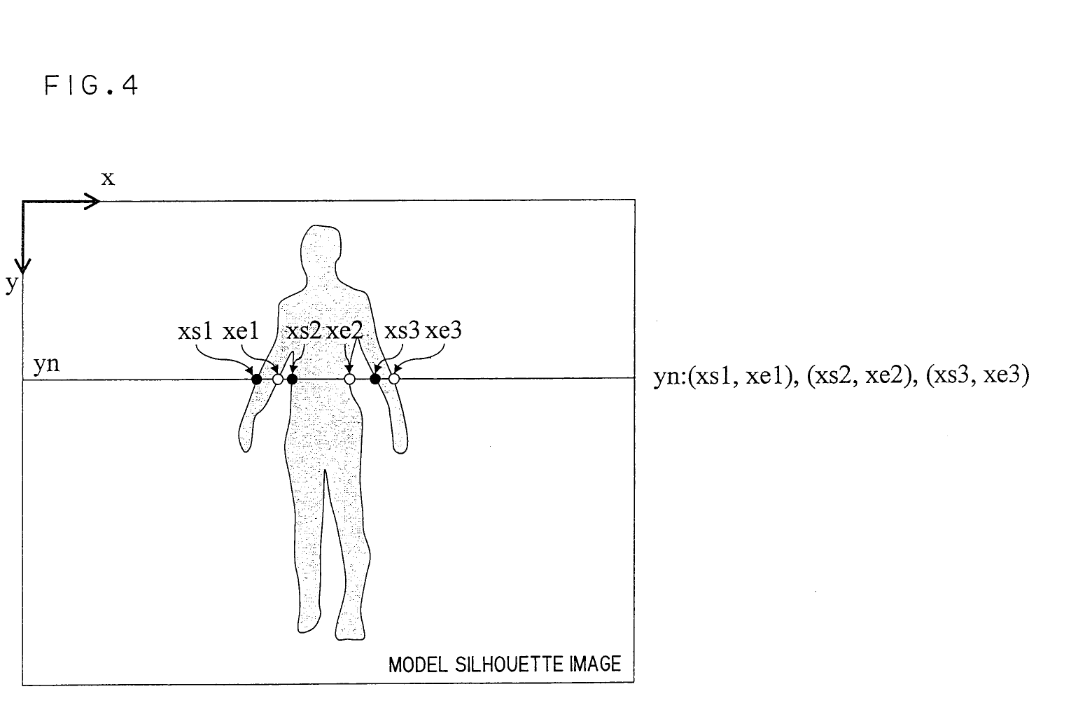

As shown in FIG. 4, the model silhouette is a set of the pixels each having any one of the portion index numbers as a pixel value. In order to reduce the size of the posture dictionary A, pairs of a starting point and a terminal point in the x (horizontal) direction of the silhouette are stored for each y-coordinate.

As shown in FIG. 4, there are three pairs of the starting point and the terminal point of the silhouette on a y-coordinate value yn, and the pairs (xs1, xe1), (xs2, xe2), and (xs3, xe3) are stored in the posture dictionary A as model silhouette information.

### (3-5-2) Model Outline

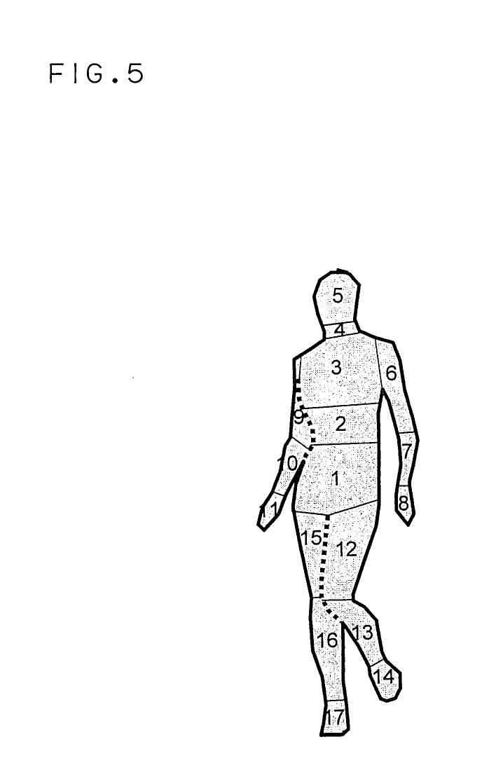

As shown in FIG. 5, the model outline is a set of pixels whose pixel values are one of the portion index numbers and whose adjacent pixel does not have the portion index numbers as its pixel value (thick solid line in FIG. 5) or have the index numbers of portions which are not connected thereto (thick dot lines in FIG. 5), and positions of such pixels are stored in the posture dictionary A as the model outline.

### (3-6) Occlusion Detection Unit 106

An occlusion detection unit 106 obtains an area (number of pixels) for the respective portions using the projected image with portion indexes, and extracts the portions having an area of 0 or an area smaller than a threshold value as occluded portions.

When storing these portions in the posture dictionary A, flags are prepared for each portion, and the flags of the occluded portions are turned on. These flags are coordinated with the joint angle data of the respective postures and are stored in the posture dictionary A.

### (3-7) Tree Structure Generating Unit 107

A tree structure generating unit 107 generates a tree structure of the posture so that the distance between the image features (that is, similarity) of the respective nodes is reduced as it goes to the lower levels on the basis of the image feature distance between the postures defined on the basis of the image features extracted by the image feature extracting unit 105.

The image feature distance d (a, b) between a posture “a” and a posture “b” is calculated on the basis of the outline information extracted by the image feature extracting unit 105 as follows.

A plurality of evaluation points Rₐ are set on the outline of the posture “a”. The evaluation points may be composed of all the pixels Cₐ on the outline, or the pixels obtained by thinning at adequate distances. Distances from a respective point pₐ of these evaluation points to the closest point among points p_{b} on an outline C_{b} of the posture “b” are calculated to obtain an average value of all the evaluation points, which corresponds to an image feature distance between the posture “a” and the posture “b”.

$$d ( a , b ) = \frac{1}{{N}_{{C}_{a}}} {\sum }_{{p}_{a} ∈ {R}_{a}} {min}_{{p}_{b} ∈ {C}_{b}} {‖ {p}_{a} - {p}_{b} ‖}^{2}$$

where, N_{ca} represents the number of the evaluation points included in Rₐ. The image feature distance is zero when the two postures are the same, and increases according to difference between projected images of the posture “a” and the posture “b”.

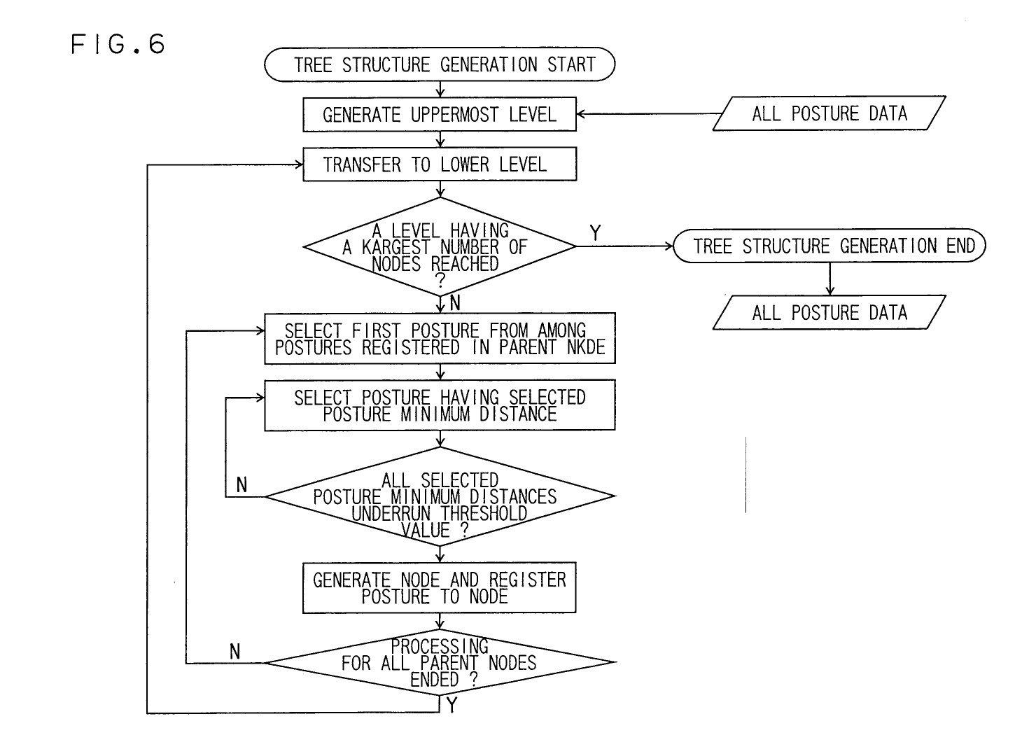

Referring now to FIG. 6, a procedure for generating the tree structure using the image feature distance will be described.

### (3-7-1) Uppermost Level Generating Step

An uppermost level, which corresponds to a root of the tree structure, is determined as a current layer, and a node is generated. All the postures acquired by the posture acquiring unit 101 are registered to this node.

### (3-7-2) Lower Level Transfer Step

The current layer is transferred to the level which is one step lower.

### (3-7-3) Ending Step

When the current layer exceeds a defined maximum number of levels, generation of the tree structure is ended. The following procedures are repeated for each of the nodes (parent nodes) of the upper level of the current level.

### (3-7-4) First Posture Selecting Step

The image feature distances between an arbitrary posture (for example, a posture which is registered first in a parent node) in the postures registered in the parent node (referred to as “parent postures”) and remaining postures are calculated and a histogram of the image feature distance is prepared. A posture which is the closest to the most frequent value of the histogram is determined as the first selected posture.

### (3-7-5) Posture Selecting Step

A minimum value of the image feature distance between the parent postures which are not selected yet and the selected postures which are already selected is calculated, and is referred to as “selected posture minimum distance.” A posture whose selected posture minimum distance is the largest is determined as a new selected posture.

### (3-7-6) Posture Selection Ending Step

When there is no selected posture minimum distance exceeding the predetermined threshold value which is specified for each level, the posture selection step is ended. By setting the threshold value so as to be smaller as it goes to the lower levels, the tree structure which has more nodes as it goes to the lower levels can be generated.

### (3-7-7) Node Generation Step

The nodes are generated for the respective selected postures and the selected postures are registered to the corresponding nodes. The generated nodes are connected to the parent nodes. The parent postures which are not selected as the selected postures are registered to a node to which a selected posture at the minimum image feature distance therefrom belongs.

### (3-7-8) End Controlling Step

When the processing is not ended for all the parent nodes, the next parent node is selected and the procedure goes back to the first posture selecting step. If it is ended, the procedure goes back to the lower level transfer step.

### (4) Data Structure of Posture Dictionary A

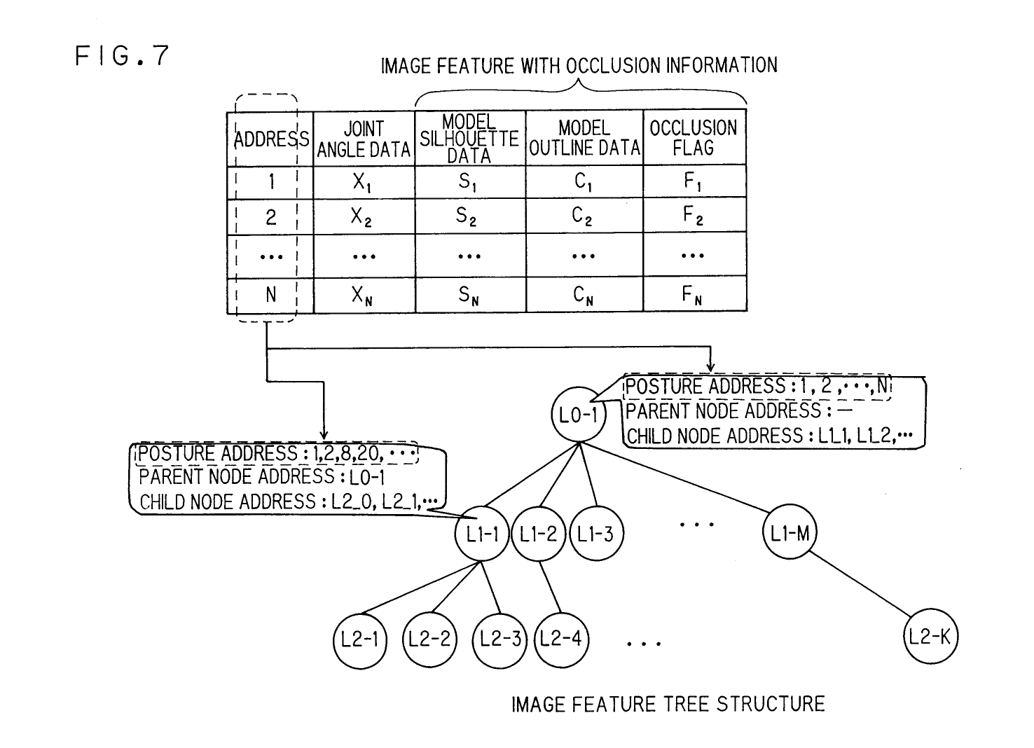

Referring now to FIG. 7, a data structure of the posture dictionary A will be described.

The joint angle data A1, the model silhouette and the model outline extracted by the image feature extracting unit 105, and the occlusion flags obtained by the occlusion detection unit 106 are stored for the respective postures acquired by the posture acquiring unit 101. The model silhouette, the model outline, and the occlusion flags are referred to as the image feature with occlusion information A2 in combination. Addresses are assigned to the respective postures, and hence all the data are accessible by referring the addresses.

The addresses are assigned also to the respective nodes of the tree structure, and the addresses of the postures which are registered to the corresponding node, and the addresses of the nodes connected thereto on the upper level and the lower level (which are referred to as parent nodes and child nodes respectively) are stored in each node. The posture dictionary A stores the set of these data relating to all the nodes as the image feature tree structure.

### (5) Method of Posture Estimation

A method of posture estimation performed from the image obtained from a camera using the posture dictionary A will be described.

### (5-1) Image Capture Unit 1

The image capture unit 1 in FIG. 1, being composed of a single camera, captures an image and transmits it to the image feature extracting unit 2.

### (5-2) Image Feature Extracting Unit 2

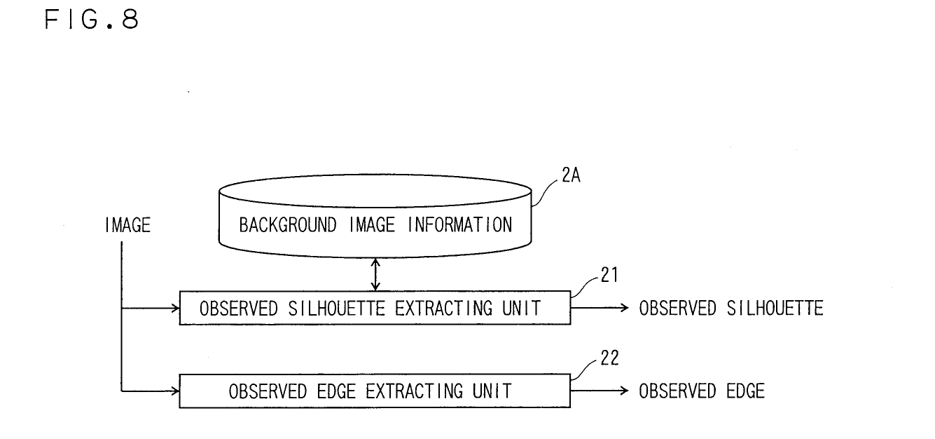

The image feature extracting unit 2 detects the silhouette and edge for the respective images transmitted from the image capture unit 1, which are referred to as an observed silhouette and an observed edge, respectively, as shown in FIG. 8.

An observed silhouette extracting unit 21 acquires a background image without a person whose posture is to be estimated in advance, and the difference in luminance or color from the image of the current frame is calculated. The observed silhouette extracting unit 21 generates the observed silhouette by assigning a pixel value 1 to pixels having the difference larger than a threshold value and a pixel value 0 to other pixels. The description given above is the most basic background difference calculus, and other background difference calculus may be employed.

An observed edge extracting unit 22 calculates gradient of the luminance or each color bands by applying a differential operator such as Sobel operator to the image of the current frame, and detects a set of pixels whose gradient assumes the maximum value as the observed edge. The description above is one of the most basic edge detection method, and other edge detection methods such as Canny edge detector can be employed.

### (5-3) Posture Prediction Unit 3

The posture prediction unit 3 predicts the posture of the current frame using a dynamic model from the posture estimation results of a previous frame.

The posture prediction may be represented by a form of a distribution of the probability density, and the state transition probability density in which the posture (joint angle) of a previous frame Xt−1 is changed to the posture Xt in the current frame may be expressed by p(Xt|Xt−1). To determine the dynamic model corresponds to determine the probability density distribution. The simplest dynamic model is a normal distribution having a predetermined certain variance-covariance matrix in which the posture of the previous frame is obtained as an average value.

p(Xₜ|Xₜ₋₁)=N(Xₜ₋₁, Σ)

where, N ( ) represents the normal distribution. That is, the dynamic model includes a parameter that determines a representative value of the predicted posture, and a parameter relating to a range of the predicted posture. In the case of the expression 2, the parameter that determines the representative value is a constant 1, which is a coefficient of the Xt−1. The parameter which relates to determination of the range of the predicted posture is a variance-covariance matrix Σ.

In addition, there are a method of linearly predicting the average value with a constant speed of the previous frame and a method of predicting the same with a constant acceleration. All these dynamic models are based on an assumption that the posture is not significantly changed from the posture of a frame one frame before.

The variance represents certainness of the prediction, and the larger the variance is, the larger the variation of the predicted posture becomes in the current frame. Assuming that the variance-covariance matrix Σ is constant, the following problem occurs when the occlusion of the portions occurs.

The current posture is determined considering the prediction (a priori probability) and conformity (likelihood) with observation obtained from the image. However, while a portion is occluded by another portion, and hence is not visible from the image capture unit 1, it cannot be observed from the image, and hence the posture of the current frame is determined by the prediction on the basis of the dynamic models. In a case in which the variance of the dynamic models is constant, when the occluded portion appears and its posture is out of the range predictable on the basis of the dynamic models, the prior probability of such a current posture is very low. Consequently, even though the conformity with the observation obtained from the image is high, the actual posture of the current frame cannot be obtained, and hence the posture estimation is failed.

This problem is solved by increasing only the variance of the occluded portion. The respective postures in the posture dictionary A include the occlusion flags of the respective portions stored therein, the occluded portion is specified using the occlusion flag relating to the posture Xt−1 of a previous frame, and the joint angle of the occluded portion is predicted by using variance larger than the portions which are not occluded. It is also possible to set a variable variance which increases gradually in proportion to the length of the occluded time of the occluded portion. For example, the upper limit value of the variance is preset, and the variance is increased in proportion to the length of the occluded time until it reaches the upper limit value, so that the variable time variance is achieved.

### (5-4) Tree Structure Posture Estimation Unit 4

The tree structure posture estimation unit 4 estimates the current posture while referring the tree structure of the posture dictionary A using a result of prediction of the posture by the posture prediction unit 3 and the observed silhouette and the observed edge as the image features extracted by the image feature extracting unit 2. Details of the posture estimating method using the tree structure are described in the above-described document by B. Stenger et.al, and an outline of this method will be described briefly below.

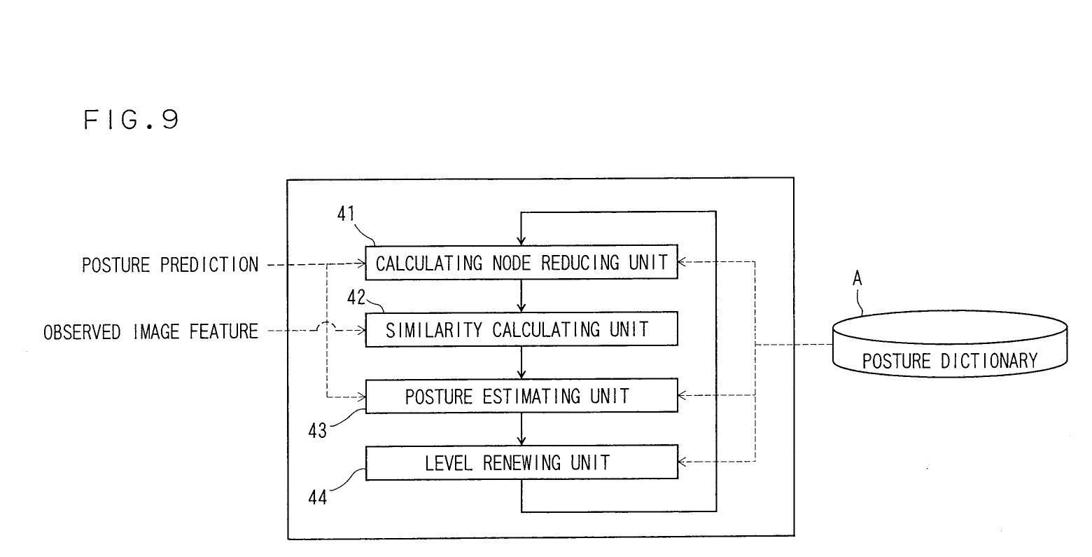

FIG. 9 shows a configuration of the tree structure posture estimation unit 4.

The respective nodes of the tree structure stored in the posture dictionary A are composed of a plurality of postures whose image features are close to each other. A posture whose sum of the image feature distance from another posture belonging to a certain node is the smallest is determined as a representing posture, and the image feature of the representing posture is determined as a representative image feature of the corresponding node. This representative image feature corresponds representing posture information

### (5-4-1) Calculating Node Reducing Unit 41

A calculating node reducing unit 41 obtains a priori probability that the representative image feature is observed as the image feature of the current frame using a posture prediction of the posture prediction unit 3 and an estimation result of a previous frame. When the priori probability is sufficiently small, it is set not to perform the subsequent calculation.

In a case in which the probability of the posture estimation result of the current frame (calculated by a posture estimating unit 43) in the upper level is obtained, it is set not to perform the subsequent calculation for the nodes of the current level which is connected to the node whose probability is sufficiently small.

### (5-4-2) Similarity Calculating Unit 42

A similarity calculating unit 42 calculates the image feature distance between the representative image features of the respective nodes and the observed image feature extracted by the image feature extracting unit 2.

The image feature distances are calculated for the various positions and scales in the vicinity of the estimated position and scale in the previous frame in order to estimate the 3D position of a person to be recognized.

The movement of the position on the image corresponds to the movement in the three-dimensional space in the direction parallel to the image plane, and the change of the scales corresponds to the parallel movement in the direction of the optical axis.

In the case of the outline, the image feature distance shown in the tree structure generating unit 107 can be used. Furthermore, a method of dividing the outline into a plurality of bands on the basis of the edge direction (for example, dividing into four bands of the horizontal direction, the vertical direction, the direction inclined rightward and upward, and the direction inclined leftward and upward) and calculating the outline distance with respect to the respective bands is often used.

In the case of the silhouette, an exclusive OR is calculated for each pixel of the model silhouette and the observed silhouette, and the sum of the values of the exclusive OR which takes 1 or 0 is determined as a silhouette distance. In addition, there is also a method of weighting to work out the sum as it approaches the center of the observed silhouette when calculating the sum of the values of the exclusive OR.

The Gauss distribution is assumed as the likelihood model using the silhouette distance and the outline distance to calculate the likelihood (the likelihood of the observation given a certain node).

In this apparatus, the calculation of the similarity, which is the processing of the similarity calculating unit 42, requires the largest amount of computational resources because it is preformed for a large number of nodes. With the posture dictionary A stored in this apparatus configured on the basis of the image feature distances, the postures whose image features are similar are registered in the same node even though the joint angle is significantly different from each other, and hence it is not necessary to calculate the similarity separately for these postures, so that the amount of calculation is reduced and efficient search is achieved.

### (5-4-3) Posture Estimation Unit 43

The posture estimation unit 43 obtains firstly the posterior probability of the respective node given the current observed image feature based on Bayes estimation from the priori probabilities and the likelihoods of the respective nodes.

The distribution of this probabilities itself corresponds to the estimation result of the current level. However, in the case of the lowest level, the current posture may be determined uniquely. In this case, the node which has the highest probability is selected.

When the selected node in the lowest level includes a plurality of postures, the state transition probability is calculated between the postures registered in the selected node and the estimated posture in the previous frame, and the posture having the highest transition probability is outputted as the current posture.

Since the posture prediction unit 3 performs prediction while taking the occluded portions into consideration, the priori probability does not become low even though the posture is significantly different before and after the occlusion, and stable posture estimation is achieved even though the occlusion occurs.

### (5-4-4) Level Renewing Unit 44

Lastly, a level renewing unit 44 transfers the processing to the lower level if the current level is not the lowest level, and terminates the posture estimation if it is the lowest level.

With the apparatus configured as described above, the efficient and stable posture estimation of the human body is achieved.

### (6) Modification 1

The number of cameras is not limited to one, and a plurality of the cameras may be used.

In this case, the image capture unit 1 and the virtual image capture unit 104 consist of the plurality of cameras, respectively. Accordingly, the image feature extracting unit 2 and the image feature extracting unit 105 perform processing for the respective camera images, and the occlusion detection unit 106 sets the occlusion flags for the portions occluded from all the cameras.

The image feature distances (the silhouette distance or the outline distance) calculated by the tree structure generating unit 107 and the similarity calculating unit 42 are also calculated for the respective camera images, and an average value is employed as the image feature distance. The silhouette information, the outline information to be registered in the posture dictionary A, and the background information used for the background difference processing by the observed silhouette extracting unit 21 are held separately for the respective camera images.

### (7) Modification 2

When performing the search using the tree structure, a method of calculating the similarity using a low resolution for the upper levels and a high resolution for the lower levels is also applicable.

With the adjustment of the resolution as such, the calculation cost for calculating the similarity in the upper levels is reduced, so that the search efficiency may be increased.

Since the image feature distance between the nodes is large in the upper levels, the risk of obtaining a local optimal solution increases if the search is performed by calculating the similarity with the high resolution. In terms of this point, the adjustment of the resolution as described above is effective.

When the plurality of resolutions are employed, the image features relating to all the resolutions are obtained by the image feature extracting unit 2 and the image feature extracting unit 105. The silhouette information and the outline information on all the resolutions are also registered in the posture dictionary A. When transferring the processing to the next level by the level renewing unit 44, the resolution used in the next level is selected.

### (8) Modification 3

Although the silhouette and the outline are used as the image features in the embodiment shown above, it is also possible to use only the silhouette or only the outline.

When only the silhouette is used, the silhouette is extracted by the image feature extracting unit 105, and the tree structure is generated on the basis of the silhouette distance by the tree structure generating unit 107.

The outline may be divided into to boundaries; a boundary with the background (the thick solid line in FIG. 5) and a boundary with other portions (the thick dot line in FIG. 5). However, since the boundary with the background includes information overlapped with the silhouette, the outline distance may be calculated using only the boundary with other portions by the similarity calculating unit 42.

### (9) Other Modifications

The invention is not limited to the embodiments shown above, and may be embodied by modifying components without departing from the scope of the invention in the stage of implementation. Various embodiments may be configured by combining the plurality of components disclosed in the embodiments shown above as needed. For example, several components may be eliminated from all the components shown in the embodiments. Alternatively, the components in the different embodiments may be combined as needed.

What is claimed is:

1. An apparatus for estimating current posture information of a human body from an image of the human body captured by one or more image capture devices comprising:
a posture dictionary configured to store tree structure data including a plurality of nodes each including
(A) posture information on various postures of the human body obtained in advance,
(B) image feature information on the respective postures and
(C) representing posture information indicating representing posture of the various postures in the respective nodes,
the image feature information including
(B-1) information on at least one of silhouettes,
(B-2) outlines of the respective postures and
(B-3) occlusion information on portions of the human body which are occluded by the human body itself,
the nodes being arranged in such a manner that the nodes in the lower level includes postures having higher similarity than in the higher level;
an image feature extracting unit configured to extract observed image feature information observed from the images obtained by the image capture device;
a past information storage unit configured to store past posture estimation information of the human body;
a posture predicting unit configured to predict a predicted posture based on the past posture estimation information and the occlusion information of the respective portions, the posture predicting unit setting a predicted range of a dynamic model for occluded portions larger than that for potions without occlusion;
a node predicting unit configured to calculate a prediction probability relating to whether a correct posture corresponding to the current posture is included in the respective nodes of the respective levels of the tree structure using the predicted range and the past posture estimation information;
a similarity calculating unit configured to calculate the similarity between the observed image feature information and the image feature information on the representing postures in the respective nodes stored in the posture dictionary;
a node probability calculating unit configured to calculate the probability that the correct posture is included in the respective nodes of the respective levels from the prediction probabilities and the similarity in the respective nodes; and
a posture estimation unit configured to select posture information which is closest to the predicted posture from the plurality of postures included in the node having the highest probability in the lowest level of the tree structure as the current posture estimation information.

2. The apparatus according to claim 1, comprising a calculation node reducing unit configured to determine nodes to be calculated by the similarity calculating unit on the basis of the prediction probabilities in the respective nodes and the probabilities that the correct posture is included in the respective nodes in the upper level of the tree structure.

3. The apparatus according to claim 1, wherein the dynamic models each include a first parameter that determines a representative value of the predicted posture and a second parameter relating to determination of a range which can be considered as the predicted posture, and
wherein the posture predicting unit sets the predicted range of the current posture on the basis of a history of the past posture estimation information and the dynamic models and, when setting the range, sets the second parameter so that the predicted range of the occluded portion is larger than the portion not occluded in the past posture estimation information.

4. The apparatus according to claim 1, wherein the image feature information with the occlusion information includes a silhouette or an outline or both and an inner outline which is a boundary of an overlapped portions different from the silhouette obtained by deforming a three-dimensional shape model of a human body prepared in advance into the postures stored in the posture dictionary and projecting the same virtually on an image plane of the image capture device, and
wherein the occlusion information is flags relating to the respective portions indicating that the area of the portion projected on the image plane is smaller than a threshold value.

5. The apparatus according to claim 1, wherein the tree structure includes nodes each including a set of postures whose similarity with respect to each other is higher than a threshold value,
wherein the threshold value is larger as it goes to the lower levels, and is the same among the nodes in the same level, and
wherein the respective nodes in the respective levels each are connected to a node which has the highest similarity thereto among the nodes in the higher levels.

6. The apparatus according to claim 1, wherein the posture information is joint angles of the respective portions.

7. The apparatus according to claim 1, wherein the predicted range is variance.

8. The apparatus according to claim 1, wherein the prediction probability is a priori probability.

9. A method of estimating current posture information of a human body from an image of the human body captured by one or more image capture devices, comprising:
storing a tree structure data including a plurarity of nodes each including,
(A) posture information on various postures of the human body obtained in advance,
(B) image feature information on the respective postures and
(C) representing posture information indicating representing posture of the various postures in the respective nodes,
the image feature information including
(B-1) information on at least one of silhouettes,
(B-2) outlines of the respective postures and
(C-2) occlusion information on portions of the human body which are occluded by the human body itself,
the nodes being arranged in such a manner that the nodes in the lower level includes postures having higher similarity than in the higher level;
extracting observed image feature information observed from the images obtained by the image capture device;
storing past posture estimation information of the human body;
predicting a predicted posture based on the past posture estimation information and the occlusion information of the respective portions, and setting a predicted range of a dynamic model for occluded portions larger than that for portions without occlusion;
calculating a prediction probability relating to whether a correct posture corresponding to the current posture is included in the respective nodes of the respective levels of the tree structure using the predicted range and the past posture estimation information;
calculating the similarity between the observed image feature information and the image feature information on the representing postures in the respective nodes stored in the posture dictionary;
calculating the probability that the correct posture is included in the respective nodes of the respective levels from the prediction probabilities and the similarity in the respective nodes; and
selecting posture information which is closest to the predicted posture among the plurality of postures included in the node having the highest probability in the lowest level of the tree structure as the current posture estimation information.

10. A posture estimation program stored in a computer readable media, the program estimating current posture information of a human body from an image captured by a one or more image capture device, the program realizing:
a posture dictionary function for storing a tree structure data including a plurality of nodes each including,
(A) posture information on various postures of the human body obtained in advance,
(B) image feature information on the respective postures and
(C) representing posture information indicating representing posture of the various postures in the respective nodes,
the image feature information including
(B-1) information on at least one of silhouettes,
(B-2) outlines of the respective postures and
(B-3) occlusion information on portions of the human body which are occluded by the human body itself,
the nodes being arranged in such a manner that the nodes in the lower level includes postures having higher similarity than in the higher level;
an image feature extracting function for extracting observed image feature information observed from the images obtained by the image capture device;
a past information storing function for storing past posture estimation information of the human body;
a posture predicting function for predicting a predicted posture based on the past posture estimation information and the occlusion information of the respective portions, and setting a predicted range of a dynamic model for occluded portions larger than that for portions without occlusion;
a node predicting function for calculating a prediction probability relating to whether a correct posture corresponding to the current posture is included in the respective nodes of the respective levels of the tree structure using the predicted range and the past posture estimation information;
a similarity calculating function for calculating the similarity between the observed image feature information and the image feature information on the representing postures in the respective nodes stored in the posture dictionary;
a node probability calculating function for calculating the probability that the correct posture is included in the respective nodes of the respective levels from the prediction probabilities and the similarity in the respective nodes; and
a posture estimation function for selecting posture information which is closest to the predicted posture among the plurality of postures included in the node having the highest probability in the lowest level of the tree structure as the current posture estimation information.
